(19) United States
(12) Patent Application Publication
(10) Pub. No.: US 2002/0091622 A1
(43) Pub. Date: Jul. 11, 2002

(54) Check and trade, the pre-trading compliance enforcement system for insiders in a company

(76) Inventors: Angelica M.T. Mastwyk, De Meern (NL); Theo Van Koningsveld, De Meern (NL)

Correspondence Address: A.S.A.P., HEMELVUUR 2, DE MEERN, 3454SV, NL

(21) Appl. No.: 09/923,314

(22) Filed: Aug. 7, 2001

Related U.S. Application Data
(60) Provisional application No. 60/222,631, filed on Aug. 3, 2000.

(51) Int. Cl. G06F 17/60

(52) U.S. Cl. 705/37

(57) ABSTRACT

The system enables people who trade in stock listed securities to check whether a transaction is compliant with existing laws, rules and company regulations before an intended transaction is actually executed. An unambiguous ‘Yes or No’ will be provided regarding the question whether the intended transaction is compliant with existing laws, rules and company regulations. This answer is provided by a computer system that by means of a rules or decision engine running against a database with data on clients, rules, market news and other relevant data about the insider determines the correct answer whether a transaction will be compliant or not. This indication is therefor of a pre-trading nature.

### BACKGROUND OF THE INVENTION

The supervision by regulators of the stock exchanges (e.g. SEC in the USA) on Insider Trading by company staff is getting stricter every day also in Europe. At the same time much more private individuals are investing actively on the stock exchange to improve their financial situation for their retirement. Also employee stock options and stock schemes are becoming more popular in the European listed companies. The employers of these private investors are running an enormous reputation risk if their staff is connected to insider trading. This might hurt the company's stock price in a big way and might lower the company's value by billons of Euro's or dollars.

Our system enables the employer and it's compliance department to efficiently manage the related information and warn insiders beforehand in the pre-trading stage whether an investment transaction on the stock exchange in a specific instrument is at that time compliant with the legal rules and internal company regulations. By synchronising this check with the real time stock exchange prices, the online news and other market data the compliance department can put an intended deal into the proper context.

### BRIEF SUMMARY OF THE INVENTION

Our Invention enables companies, banks and other financial institutions to enforce legal compliance rules to their staff. Staff members who intend to do a transaction on a stock exchange get an unambiguous answer (Yes or NO) to the question whether that security's transaction at that given moment is compliant to the existing legal rules and the internal regulations of the employer.

### DETAILED DESCRIPTION OF THE INVENTION

Check-N-Trade is building a system which can offer these services. The main components of this system are:

The Customer database: this database contains the personal data of all Check-N-Trade customers, including details from the registration form such as position, the nature of the internal information to which the employee has access, his/her partner and/or family members. Staff participating in option schemes can also be registered in this database.

The rules database: this database contains all legal and financial data that are relevant in the process of determining whether a transaction is permitted. General legal information as well as specific data concerning take-overs, mergers etc., will therefore be included. This expertise will be provided in co-operation with the accountant- and consultancy partner involved. The relevant data are translated into a rules-set (part of the decision engine) which ultimately shows if a deal is legitimate or not at that point in time.

News database: Check-N-Trade will purchase relevant economic and business news from a third party (e.g. Reuters, Bridge). This news will be spread amongst Check-N-Trade customers and will be logged, in order to have it synchronised in a later stadium, with checks and transactions done by clients.

Decision engine: This part of the system determines whether a certain transaction is allowed, based on the information contained in the customer database and rules databases.

Historical log: It is essential to be able, at any given time, to determine whether a certain transaction was legally permitted at a certain point in time, based on the data recorded in the system at that particular moment. Therefore, an extensive historical logging of news, share prices, transactions and checks per client will have to take place.

Check-N-Trade External API: a service API that enables existing stock broking companies and banks to integrate the Check-N-Trade service in their flow.

Web-interface: Check-N-Trade will implement its own website on which C-N-T customers can check whether they are permitted to conclude certain transactions. This is a stand-alone service and therefore not integrated into other systems.

The web-based interface for the intranet or WAN for large financial institutions.

The modelling of the insider knowledge is done based on two approaches;

the official hierarchy of the company. This is the functional model of the organisation on which most Chinese walls are based.

the dynamic information flows which stream through the organisation over time. The design is based on plug gable rules for several core banking information flows, such as; The Credit Process, I.P.O's, Structured Finance Workflow etc. Once the start of such a flow is registered the next steps in the process, including the insiders involved, are immediately closed for trading.

The combination of these two approaches creates a dynamic process in which the compliance rules can be much more flexible, to the point and in real-time. Based on the personal profile of each employee in the Personal Insider Profile (PIP)-form.

### Setting Up the System

This paragraph describes all the information that must be entered in the system or application.

The Decision Flow

At the basis of every compliance decision is the question whether a staff member has knowledge about a company or other market relevant information to which he has access solely because of his profession and to which other investors have no access at that time.

To answer this question we have developed a Personal Insiders Profile form (PIP form), which every insider in a company has to fill in. It profiles his job content, the type of information he has access to, his personal situation with first line relatives, and all other data that are needed to profile him.

Setting Up the System

In order to run the system the following data will be put into the system;

All company names and stock codes of the stock exchanges on which staff is allowed to deal.

Legal hierarchy of the companies in the database (mother and daughter relationships)

All insider staff, their job titles, departments and other organisational parameters.

The official organisation chart of the company for which the system is implemented.

Standard workflows for several routines in the company. For a bank for example the credit approval process, merger and acquisitions process etc.

Relations between persons, departments and clients.

The existing and new investment transactions of all staff.

We claim as our invention the system design that combines the following features:

1. The ability to give an unambiguous answer (yes or no) to the question whether a security transaction on the stock exchange at that moment is compliant with legal rules and company regulations before the transaction is executed.

2. The ability to do so based on actual daily updated information about the job content and job activities of the staff involved and the workflows within the organisation. A periodic email or other alert message will ask the insiders whether they have any new knowledge that they want to have added to their Personal Insider Profile.

3. The ability to combine the data from the Personal Insiders Profile form with the data mentioned above and also synchronise those with real-time online news, stock prices and other publicly known market news in order to put the request for trading in a proper context which might be used in later proceedings.
